(19) United States
(12) Patent Application Publication
(10) Pub. No.: US 2026/0370445 A1
(43) Pub. Date: Nov. 19, 2026

(54) METHOD AND DEVICE FOR PERFORMING OPERATION BEING SECURE AGAINST SIDE CHANNEL ATTACK AND COMPUTING SYSTEM

(71) Applicant: SAMSUNG ELECTRONICS CO., LTD., Suwon-si (KR)

(72) Inventors: Young-Sik KIM, Daegu-si (KR); Jae Ho JEON, Daegu-si (KR); Myung Hyun CHO, Suwon-si (KR); Bo Gyeong KANG, Suwon-si (KR); Min KIM, Suwon-si (KR); Seong Gyeom KIM, Suwon-si (KR); Ji Myung NA, Suwon-si (KR)

(73) Assignees: SAMSUNG ELECTRONICS CO., LTD., Suwon-si (KR); Daegu Gyeongbuk Institute of Science and Technology, Daegu (KR)

(21) Appl. No.: 19/673,340

(22) Filed: May 11, 2026

(30) Foreign Application Priority Data
May 13, 2025 (KR) 10-2025-0061997

(51) Int. Cl. H04L 9/00

(52) U.S. Cl. CPC H04L 9/002

(57) ABSTRACT

A method for performing an operation includes: inserting, by a processor, a dummy index into a plurality of indexes constituting a first polynomial; selecting, by the processor, two or more adjacent indexes from among the plurality of indexes including the dummy index; generating a first index set including the selected two or more adjacent indexes; and performing, by the processor, partial product operations between indexes belonging to the first index set and a second polynomial in a parallel manner.

### CROSS-REFERENCE TO RELATED APPLICATION

This application claims priority from Korean Patent Application No. 10-2025-0061997, filed on May 13, 2025, in the Korean Intellectual Property Office, the disclosure of which is incorporated by reference herein in its entirety.

### BACKGROUND

### 1. Field

The present disclosure relates to a method and device for performing an operation, and a computing system that are safe against a side channel attack.

### 2. Description of Related Art

A sparse polynomial is a polynomial that has relatively few non-zero terms, which allows for efficient multiplication between polynomials. In a multiplication operation of the sparse polynomial and a normal polynomial (or a dense polynomial), a position of the non-zero term in the sparse polynomial may be stored in a form of an index, and the normal polynomial may be shifted according to the index of the sparse polynomial and the operation may be performed. Thus, an operation amount and a memory use amount may be reduced.

As a countermeasure against cryptanalysis using quantum computing technology, Post-Quantum Cryptography (PQC) has been proposed. Hamming Quasi-Cyclic (HQC) is a quantum-resistant cryptographic algorithm that uses a polynomial-to-polynomial multiplication operation as one of main operations. In this operation, the index of the sparse polynomial is secret information. Thus, it is necessary for the index to be safe against a side channel attack that analyzes an operation execution time, power consumption, etc.

### SUMMARY

One or more embodiments provide a method for performing an operation being safe against side channel attack.

One or more embodiments also provide a device for performing an operation that performs a method for performing an operation being safe against a side channel attack.

One or more embodiments also provide a computing system that performs a method for performing an operation being safe against a side channel attack.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using features shown in the claims and combinations thereof.

According to an aspect of an embodiment, a method for performing an operation, includes: inserting, by a processor, a dummy index into a plurality of indexes constituting a first polynomial; selecting, by the processor, two or more adjacent indexes from among the plurality of indexes including the dummy index; generating a first index set including the selected two or more adjacent indexes; and performing, by the processor, partial product operations between indexes belonging to the first index set and a second polynomial in a parallel manner.

According to another aspect of an embodiment, a device for performing an operation, includes: an operation controller configured to output a first index set including a first index and a second index, a first polynomial, and an accumulated polynomial; a buffer configured to receive and store the first polynomial; a first barrel shifter circuit configured to receive a first portion of the first polynomial from the buffer and shift the first portion according to the first index; a second barrel shifter circuit configured to receive a second portion of the first polynomial from the buffer and shift the second portion according to the second index; a first adder circuit configured to sum respective outputs of the first barrel shifter circuit and the second barrel shifter circuit; and a second adder circuit configured to add an output of the first adder circuit to the accumulated polynomial to obtain an updated accumulated polynomial and output the obtained updated accumulated polynomial.

According to another aspect of an embodiment, a computing system includes: a processor; and a memory storing instructions therein, wherein when the instructions are executed by the processor, the instructions cause the processor to: insert a dummy index into a plurality of indexes constituting a first polynomial; select two or more adjacent indexes from among the plurality of indexes including the dummy index; generate a first index set composed of the selected two or more adjacent indexes; and perform respective partial product operations between the indexes belonging to the first index set and a second polynomial in a parallel manner.

### BRIEF DESCRIPTION OF DRAWINGS

The above and other aspects and features will be more apparent from the following description of embodiments, taken in conjunction with reference to the attached drawings, in which:

FIG. 1 is a block diagram for illustrating a system according to some embodiments.

FIG. 2 is a block diagram for illustrating a memory according to some embodiments.

FIG. 3 is a flowchart for illustrating a method for performing an operation which is safe against a side channel attack according to some embodiments.

FIG. 4 is a flowchart illustrating a method for inserting a dummy index according to some embodiments.

FIG. 5 is a diagram for illustrating a method for inserting a dummy index according to some embodiments.

FIG. 6 is a diagram for illustrating a method for inserting a dummy index according to some embodiments.

FIG. 7 is a block diagram for illustrating a system according to some embodiments.

FIG. 8 is a flowchart for illustrating a method for performing an operation which is safe against a side channel attack according to some embodiments.

FIG. 9 is a diagram for illustrating a method for shuffling and arranging a plurality of indexes according to some embodiments.

FIG. 10 illustrates a method for shuffling and arranging a plurality of indexes according to some embodiments.

FIG. 11 is a flowchart for illustrating a method for performing an operation which is safe against a side channel attack according to some embodiments.

FIG. 12 is a diagram for illustrating a method for shuffling an order of respective multiplication operations between a plurality of index sets and a second polynomial according to some embodiments.

FIG. 13 is a diagram for illustrating a method for performing respective partial product operations between polynomials in a parallel manner according to some embodiments.

FIG. 14 is a circuit diagram for illustrating an operation device that performs respective partial product operations between polynomials in a parallel manner according to some embodiments.

FIG. 15 is a diagram for illustrating an operation of an operation device that performs respective partial product operations between polynomials in a parallel manner according to some embodiments.

FIG. 16 is a diagram for illustrating an operation of an operation device that performs respective partial product operations between polynomials in a parallel manner according to some embodiments.

FIG. 17 is a diagram for illustrating an operation of an operation device that performs respective partial product operations between polynomials in a parallel manner according to some embodiments.

FIG. 18 is a diagram for illustrating an operation of an operation device that performs respective partial product operations between polynomials in a parallel manner according to some embodiments.

FIG. 19 is a circuit diagram for illustrating an operation device that performs respective partial product operations between polynomials in a parallel manner according to some embodiments.

FIGS. 20 to 22 are diagrams for illustrating an operation of an operation device that performs respective partial product operations between polynomials in a parallel manner according to some embodiments.

FIG. 23 is a diagram for illustrating a computing system according to some embodiments according to some embodiments.

FIG. 24 is a diagram for illustrating a computing system according to some embodiments according to some embodiments.

### DETAILED DESCRIPTIONS

Hereinafter, embodiments are described in detail with reference to the accompanying drawings. Like components are denoted by like reference numerals throughout the specification, and repeated descriptions thereof are omitted. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure.

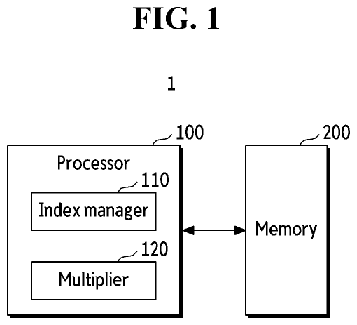

FIG. 1 is a block diagram for illustrating a system according to some embodiments.

Referring to FIG. 1, a system 1 may be embodied as, for example, a personal computer (PC), a notebook, a smartphone, a tablet, a personal digital assistant, and other types of devices capable of executing computer readable instructions. The system 1 may also be a portion of each of an integrated control system and a system manager, or may be embodied as a portable electronic device capable of communicating with a local or remote device (e.g., via wired or wireless transmission).

The system 1 may include a processor 100 and a memory 200. The processor 100 and the memory 200 may be embodied as a processing circuit. The processing circuit may include hardware, such as a logic circuit. For example, the processing circuit may include, but is not limited to, a Central Processing Unit (CPU), an Arithmetic Logic Unit (ALU), a digital signal processor, a microcomputer, a field programmable gate array (FPGA), a system-on-chip in (SoC), a programmable logic unit, a microprocessor, an application-specific integrated circuit (ASIC), and the like.

The processor 100 may include a Central Processing Unit (CPU), a Graphics Processing Unit (GPU), a programmable logic device, a specialized processor system, a microcontroller, and/or a microprocessor. In addition, the processor 100 may include an analog processor, a digital processor, a microprocessor, a multicore processor, a processor array, a network processor, or the like.

The memory 200 may store therein data and computer readable instructions. The memory 200 may include a volatile memory such as a static random access memory in SRAM) and/or a dynamic random access memory (DRAM), or may include a non-volatile memory such as a flash memory, a phase-change RAM (PRAM), a resistive RAM (RRAM), and a magnetic RAM (MRAM). The memory 200 may be integrated with the processor 100 into one chip or integrated circuit. However, embodiments are not limited thereto. The memory 200 and the processor 100 may be operatively coupled to each other, and may communicate with each other via a I/O port, a network connection, or the like, so that the processor 100 may read the data, computer-readable instructions, etc. stored in the memory 200.

According to some embodiments, when the computer readable instructions stored in the memory 200 is executed by the processor 100, the computer readable instructions may cause the processor 100 to perform a method for performing an operation being safe against a side channel attack. The operation may include a multiplication operation between two polynomials. The two polynomials may be a normal polynomial and a sparse polynomial, respectively. However, embodiments are not limited thereto.

According to some embodiments, the processor 100 may include an index manager (e.g., index manager circuit) 110 and a multiplier (e.g., multiplier circuit) 120. Each of the index manager 110 and the multiplier 120 may be embodied as one of hardware composed of a set of one or more logic circuits, and the hardware may execute software implemented by an instruction.

According to some embodiments, the index manager 110 may insert a dummy index into a plurality of indexes constituting a first polynomial. The first polynomial may be, for example, a sparse polynomial. However, embodiments are not limited thereto. The sparse polynomial refers to a polynomial that has relatively few non-zero terms compared to its degree. The first polynomial may be an element on a binary extension finite field (GF(2ⁿ)). When the first polynomial is the sparse polynomial, a non-zero term of the first polynomial may be expressed based on an index. For example, when a plurality of indexes constituting the first polynomial are {1, 11}, the first polynomial may be a polynomial in which terms other than first and 11^{th} terms are 0. The dummy index indicates an index that does not constitute the first polynomial.

According to some embodiments, the index manager 110 may select two or more adjacent indexes from among the plurality of indexes to generate a first index set composed of the selected two more adjacent indexes. For example, the indexes of the first polynomial into which the dummy index is inserted may be arranged in an ascending order. Two indexes being adjacent to each other indicates that when the indexes are arranged in the ascending order (or a descending order), an index is absent (i.e., not provided) between the two indexes adjacent to each other. The index manager 110 may select p adjacent indexes (p is a natural number of 2 or greater) among the plurality of indexes and generate a plurality of index sets including the first index set using the selected p adjacent indexes.

According to some embodiments, the multiplier 120 may perform respective partial product operations between the second polynomial and the indexes belonging to the first index set in a parallel manner. The second polynomial may be, for example, a normal polynomial. However, embodiments are not limited thereto. The normal polynomial may also be referred to as a dense polynomial. The second polynomial may be an element on a binary extension finite field (GF(2ⁿ)). The multiplier 120 may receive the first index set, the normal polynomial, and an accumulated polynomial, and obtain an updated accumulated polynomial by adding the accumulated polynomial to a result value obtained by performing the respective partial product operations between the second polynomial and the indexes belonging to the first index set in a parallel manner. The multiplier 120 may repeat the respective partial product operations between the other index sets and the second polynomial in a parallel manner to perform the multiplication operation between the first polynomial and the second polynomial. A method for performing the partial product operation in a parallel manner will be described in more detail below.

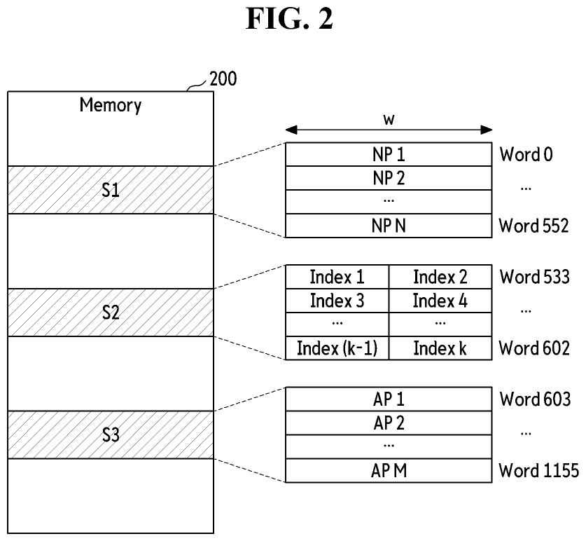

FIG. 2 is a block diagram for illustrating a memory according to some embodiments.

Referring to FIG. 2, a normal polynomial may be stored in a first space S1 of a memory 200, a sparse polynomial composed of a plurality of indexes may be stored in a second space S2 thereof, and an accumulated polynomial may be stored in a third space S3 thereof. The normal polynomial may be stored, for example, on a word (e.g., 32 bits) basis. Hereinafter, it is assumed that a format and a size of the parameter comply with HQC-128. However, this is only an example, and embodiments are not limited thereto. The normal polynomial may be composed of, for example, 553 words and may have a total size of 17,669 bits. The words may be stored in an order from a low level address to a high level address, and the least significant bit LSB to the most significant bit MSB of each word may be stored. In this case, only 5 bits of the highest level address (Word 552) may be valid, and the remaining 27 bits thereof may be treated as invalid (null).

The sparse polynomial may be stored in the form of an index, may have a range of [0, 17668], and may be expressed as a minimum of 15 bits. Because 16 bits may be allocated to each index, two indexes may be stored in one word. The indexes may be arranged and stored in an order from a small value to a large value. The sparse polynomial may include, for example, 65 to 75 indexes, and may further include a dummy index. The sparse polynomial may have 100 indexes, and may have a size of 1,600 bits.

The accumulated polynomial may include a median value or final values of the polynomial multiplication. The words thereof may be stored in an order from a low level address to a high level address and the least significant bit LSB to the most significant bit MSB of each word may be stored. In the highest level address (the Word 1155), only the lower 10 bits may be valid, and the remaining 22 bits may be treated as invalid (null). In addition, when the accumulated polynomial is loaded from the memory 200 to the processor (100 of FIG. 1), the accumulated polynomial may be loaded on a word basis such that the words are arranged in an order from a low level address to a high level address. The accumulated polynomial may be composed of, for example, 553 words. During the operation process or after the operation is completed, the accumulated polynomial may be subjected to modular reduction and then may be stored in the memory.

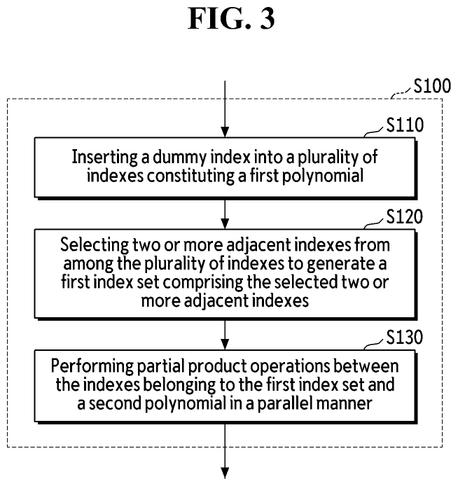

FIG. 3 is a flowchart for illustrating a method for performing an operation which is safe against a side channel attack according to some embodiments.

Referring to FIG. 3, the method S100 for performing an operation which is safe against the side channel attack may include inserting, by the processor, the dummy index into the plurality of indexes constituting the first polynomial in S110. The processor may correspond to the processor 100 of FIG. 1. The first polynomial may be, for example, a sparse polynomial. However, embodiments are not limited thereto. The sparse polynomial refers to a polynomial that has relatively few non-zero terms compared to its degree. The first polynomial may be an element on a binary extension finite field (GF(2ⁿ)). When the first polynomial is the sparse polynomial, a non-zero term of the first polynomial may be expressed as an index. For example, when the plurality of indexes constituting the first polynomial are {1, 11}, the first polynomial may be a polynomial in which terms other than the terms 1 and 11 are 0. The dummy index indicates an index that does not constitute the first polynomial.

According to some embodiments, the method S100 for performing an operation which is safe against the side channel attack may include selecting, by the processor, two or more adjacent indexes from among the plurality of indexes to generate a first index set in S120. For example, the indexes of the first polynomial into which the dummy index is inserted may be arranged in the ascending order. Two indexes being adjacent to each other indicates that when the indexes are arranged in the ascending order (or a descending order), an index is absent (i.e., not provided) between the two indexes adjacent to each other. The processor may select p adjacent indexes (p is a natural number of 2 or greater) among the plurality of indexes and generate a plurality of index sets including the first index set using the selected p adjacent indexes.

According to some embodiments, the method S100 for performing an operation which is safe against the side channel attack may include performing, by the processor, respective partial product operations between the second polynomial and the indexes belonging to the first index set in a parallel manner in S130. The second polynomial may be, for example, a normal polynomial. However, embodiments are not limited thereto. The normal polynomial may also be referred to as a dense polynomial. The second polynomial may be an element on a binary extension finite field (GF(2ⁿ)). The processor may receive the plurality of index sets including the first index set, the normal polynomial, and the accumulated polynomial, and may obtain an updated accumulated polynomial by adding the accumulated polynomial to a result value obtained by performing respective partial product operations between the second polynomial and indexes belonging to the first index set in a parallel manner. The processor may repeat the respective partial product operations between the other index sets and the second polynomial in a parallel manner to perform the multiplication operation between the first polynomial and the second polynomial.

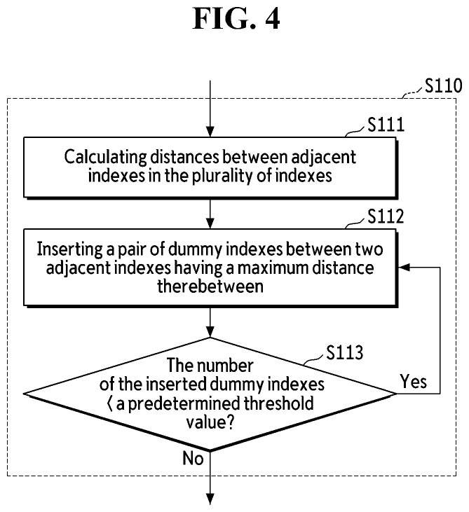

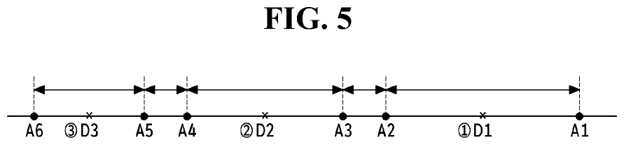

FIG. 4 is a flowchart illustrating a method for inserting a dummy index according to some embodiments. FIG. 5 is a diagram for illustrating a method for inserting a dummy index according to some embodiments.

In FIGS. 4 and 5, a method S110 for inserting a dummy index into a plurality of indexes constituting the first polynomial of FIG. 3 will be described in more detail. Referring to FIG. 4, the method S110 for inserting a dummy index into a plurality of indexes constituting the first polynomial may include calculating a distance between the indexes in the plurality of indexes S111. The distance between the indexes in the plurality of indexes indicates the distance between two adjacent indexes in the plurality of indexes. Referring to FIG. 5, for example, the processor may calculate the distance between adjacent ones of a plurality of indexes A1, A2, A3, A4, A5, and A6 constituting the first polynomial. As a result, the processor may obtain two indexes A1 and A2 having the maximum distance therebetween.

According to some embodiments, the method S110 for inserting a dummy index into a plurality of indexes constituting the first polynomial may include inserting a pair of dummy indexes between two indexes having the maximum distance therebetween in S112. For example, the processor may insert \textcircled{1} a pair of dummy indexes D1 between A1 and A2 as two indexes having the maximum distance therebetween. Because the first and second polynomials are elements on the binary extension finite field GF(2n), the addition between the polynomials may be modulo-2 addition. The modulo-2 addition may be performed via an XOR operation on a bit basis. In this regard, the XOR operation is performed on the same values, the operation result is zero. Thus, when the pair of dummy indexes is inserted, the dummy index may be erased from the final multiplication result between the polynomials.

According to some embodiments, the method S110 for inserting a dummy index into a plurality of indexes constituting the first polynomial may include determining whether the number of the inserted dummy indexes is smaller than a predetermined threshold value in S113. The predetermined threshold value may be determined according to, for example, a capacity allocated to the index in the memory. When the number of the inserted dummy indexes is smaller than the predetermined threshold value (S113-Y), operation S112 may be performed again. For example, the dummy indexes D1 are inserted between A1 and A2, such that the two indexes having the maximum distance therebetween may be A3 and A4. The processor may insert \textcircled{2} a pair of dummy indexes D2 between two indexes A3 and A4 having the maximum distance therebetween.

According to some embodiments, when the number of dummy indexes inserted by repeating the dummy index insertion \textcircled{1}, \textcircled{2}, and \textcircled{3} is equal to or greater than a predetermined threshold value (S113-N), the dummy index insertion operation may be terminated.

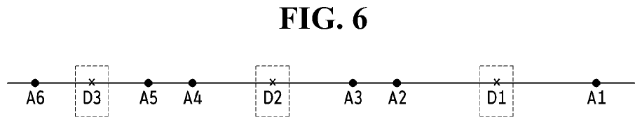

FIG. 6 is a diagram for illustrating a method for inserting a dummy index according to some embodiments.

Referring to FIG. 6, unlike FIG. 5, a dummy index to be inserted may be predetermined. For example, the processor may insert dummy index pairs predetermined as pairs of D1, D2, and D3 between the plurality of indexes.

According to some embodiments, unlike FIG. 5, the dummy index to be inserted may be randomly generated. For example, the processor may randomly generate the dummy index pairs to be inserted. The processor may insert the randomly generated pairs of dummy indexes D1, D2, and D3 between the plurality of indexes.

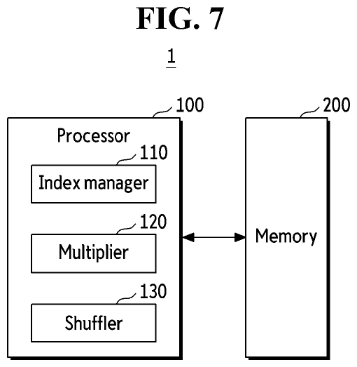

FIG. 7 is a block diagram for illustrating a system according to some embodiments.

Referring to FIG. 7, unlike FIG. 1, FIG. 7 may further include a shuffler (e.g., shuffler circuit) 130. The shuffler 130 may be embodied as one of hardware composed of a set of one or more logic circuits, and the hardware may execute software implemented by an instruction.

According to some embodiments, the shuffler 130 may shuffle and arrange a plurality of indexes. For example, initially, the plurality of indexes may be arranged in an ascending order (or a descending order). The shuffler 130 may shuffle and rearrange the plurality of indexes arranged in the ascending order (or the descending order). A shuffling method will be described in detail below.

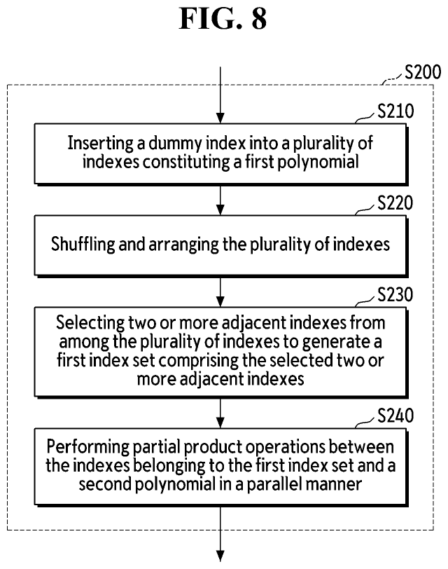

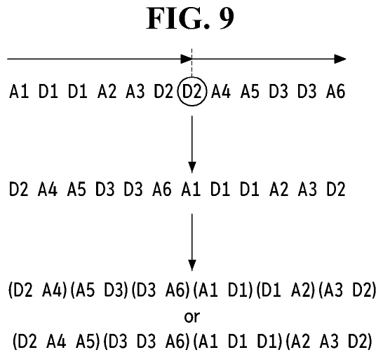

FIG. 8 is a flowchart for illustrating a method for performing an operation which is safe against a side channel attack according to some embodiments. FIG. 9 is a diagram for illustrating a method for shuffling and arranging a plurality of indexes according to some embodiments.

Referring to FIG. 8, a method S200 for performing an operation which is safe against the side channel attack may include inserting a dummy index into a plurality of indexes constituting the first polynomial in S210, and shuffling and arranging the plurality of indexes in S220. Referring to FIG. 9 together, the plurality of indexes into which the dummy indexes have been inserted may be, for example, arranged in the ascending order A1, D1, D1, A2, A3, D2, D2, A4, A5, D3, D3, and A6. The processor may randomly select one of a plurality of indexes into which the dummy indexes have been inserted. For example, D2 may be randomly selected among the plurality of indexes into which the dummy indexes have been inserted, by the processor. The processor may arrange the indexes in the ascending or descending order from the selected index. In an example, the processor may arrange the indexes in the ascending order starting from D2 (i.e., the selected index). In this regard, after the last index (e.g., A6) is positioned, the processor may arrange the indexes in the ascending or descending order from the first index (e.g., A1) again. As a result, the indexes may be arranged in a following order: D2, A4, A5, D3, D3, A6, A1, D1, D1, A2, A3, D2.

According to some embodiments, the method S200 for performing an operation which is safe against the side channel attack may include selecting, by the processor, two or more adjacent indexes from the plurality of indexes to generate a first index set composed of the selected two or more adjacent indexes in S230. Referring to FIG. 9 together, the processor may select the two or more adjacent indexes from the plurality of indexes (e.g., D2, A4, A5, D3, D3, A6, A1, D1, D1, A2, A3, and D2) that have been shuffled and arranged to generate a plurality of index sets including the first index set. In an example, when the processor selects the two indexes, the processor may generate six index sets: (D2, A4), (A5, D3), (D3, A6), (A1, D1), (D1, A2), and (A3, D2). In another example, when the processor selects three indexes, the processor may generate four index sets: (D2, A4, A5), (D3, D3, A6), (A1, D1, D1), and (A2, A3, D2). The index sets may have an order. The order may be a multiplication operation order with the second polynomial. For example, when the processor selects the two indexes to generate the six index sets, a multiplication operation between a first index set D2 and A4 and the second polynomial may be performed in a prioritized manner over a multiplication operation between the second index sets A5 and D3 and the second polynomial.

According to some embodiments, the method S200 for performing an operation which is safe against the side channel attack may include selecting, by the processor, two or more adjacent indexes from the plurality of indexes to generate the first index set composed of the two or more adjacent indexes in S230. For example, the processor may receive a plurality of index sets including the first index set, the normal polynomial, and the accumulated polynomial, and may obtain an updated accumulated polynomial by adding the accumulated polynomial to a result value obtained by performing respective partial product operations between the second polynomial and the indexes belonging to the first index set in a parallel manner. The processor may repeat the respective partial product operations between the other index sets and the second polynomial in a parallel manner to perform a multiplication operation between the first polynomial and the second polynomial. In this regard, respective partial product operations between the index sets the second polynomial in a parallel manner may be performed according to the order determined in operation S230.

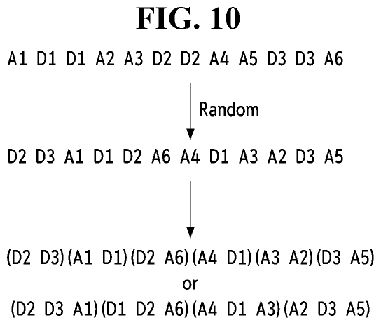

FIG. 10 is a diagram for illustrating a method for shuffling and arranging a plurality of indexes according to some embodiments.

FIG. 10 illustrates a method for shuffling and arranging a plurality of indexes according to some embodiments. Referring to FIG. 10, the plurality of indexes into which the dummy indexes have been inserted may be arranged, for example, in the ascending order A1, D1, D1, A2, A3, D2, D2, A4, A5, D3, D3, and A6. The processor may randomly shuffle the plurality of indexes into which the dummy indexes have been inserted. In an example, the processor may randomly shuffle and arrange the indexes in a following order: D2, D3, A1, D1, D2, A6, A4, D1, A3, A2, D3, and A5.

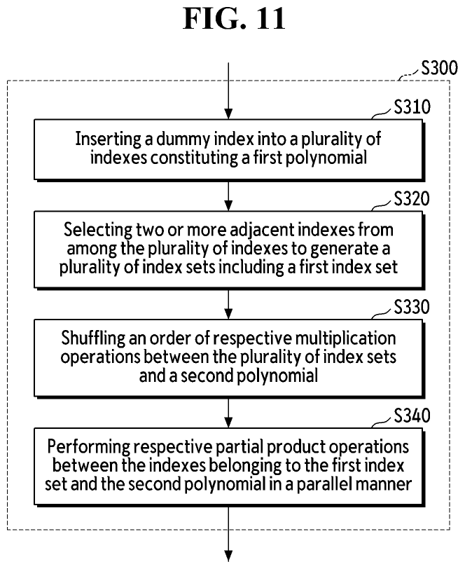

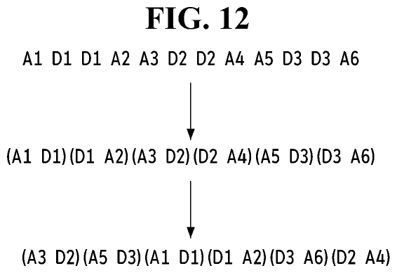

FIG. 11 is a flowchart for illustrating a method for performing an operation which is safe against a side channel attack according to some embodiments. FIG. 12 is a diagram for illustrating a method for shuffling an order of respective multiplication operations between a plurality of index sets and a second polynomial according to some embodiments.

Referring to FIG. 11, the method S300 for performing an operation which is safe against a side channel attack may include inserting a dummy index into a plurality of indexes constituting a first polynomial in S310), and generating a plurality of index sets including the first index set by selecting two or more adjacent indexes from the plurality of indexes in S320. Referring to FIG. 12 together, the plurality of indexes into which the dummy index is inserted may be, for example, the states A1, D1, D1, A2, A3, D2, D2, A4, A5, D3, D3, and A6 arranged in ascending order.

The processor may generate a plurality of index sets including the first index set by selecting two or more adjacent indexes from the plurality of arranged indexes. In an example, when the processor selects two indexes, the processor may generate six index sets: (A1, D1), (D1, A2), (A3, D2), (D2, A4), (A5, D3), (D3, A6). As another example, when the processor selects three indexes, the processor may generate four index sets: (A1, D1, D1) (A2, A3, D2), (D2, A4, A5), (D3, D3, A6). It is assumed that the processor selects two indexes to generate an index set. The index sets may have an order. The order may be a multiplication operation order with the second polynomial. For example, the first index sets A1 and D1 may be multiplied with the second polynomial in preference to the second index sets D1 and A2.

According to some embodiments, the method S300 for performing an operation which is safe against the side channel attack may include shuffling an order of respective multiplication operations between the plurality of index sets and the second polynomial in S330. Referring to FIG. 12 together, the processor may select two indexes from among a plurality of indexes into which the dummy indexes have been inserted to generate a plurality of index sets including a first index set, and shuffle an order of respective multiplication operations between the second polynomial and the plurality of index sets. In an example, when the processor selects two indexes, the processor may generate six index sets: (A1, D1), (D1, A2), (A3, D2), (D2, A4), (A5, D3), and (D3, A6). The processor may shuffle an order of respective multiplication operations between the second polynomial and the plurality of index sets in this way: (A3, D2), (A5, D3), (A1, D1), (D1, A2), (D3, A6), and (D2, A4). The shuffling method includes, for example, a random shuffling method. However, embodiments are not limited thereto. The index sets may have an order. The order may be the multiplication operation order thereof with the second polynomial. For example, the first index set A3 and D2 may be multiplied with the second polynomial in a prior manner to the multiplication between the second polynomial and the second index set A5 and D3.

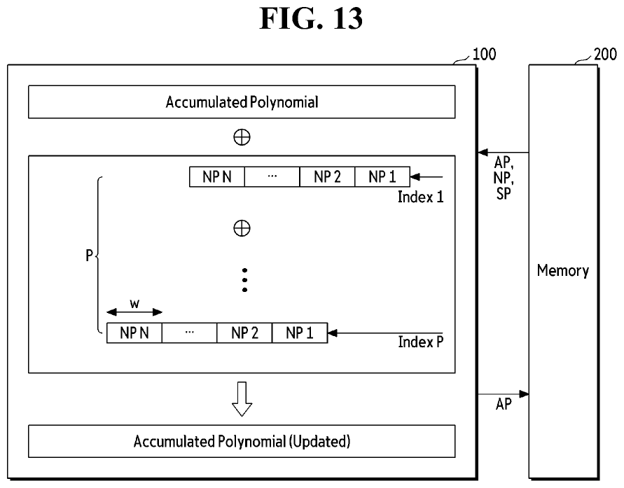

FIG. 13 is a diagram for illustrating a method for performing respective partial product operations between polynomials in a parallel manner according to some embodiments.

Referring to FIG. 13, the processor 100 may receive an accumulated polynomial AP, a normal polynomial NP, and a sparse polynomial SP from the memory 200. The sparse polynomial SP may be received in a form of a plurality of indexes constituting the sparse polynomial SP. The processor 100 may perform a multiplication operation between the normal polynomial NP and the sparse polynomial SP, and may add the multiplication operation result to the received accumulated polynomial AP to update the accumulated polynomial AP. The memory 200 may receive and store therein the updated accumulated polynomial AP. The multiplication operation between the normal polynomial NP and the sparse polynomial SP may be performed in a shift-and-add manner in which the normal polynomial NP is shifted based on each of the plurality of indexes and all of the shifted one or more normal polynomials NPs are added to each other. The normal polynomial NP may be composed of N portions NP_1 to NP_N, each having a word unit.

According to some embodiments, respective multiplication operations between the indexes Index_1 to Index_P belonging to one index set and the normal polynomial NP may be performed in a parallel manner. For example, the number of indexes Index_1 to Index_P belonging to one index set may be P (P is a natural number of 2 or greater). For example, when P is 2, the first index Index_1 and the second index Index_2 may belong to one index set. The processor 100 may obtain a first shifted normal polynomial by shifting a portion of the normal polynomial NP according to the first index Index_1. In addition, the processor 100 may obtain a second shifted normal polynomial by shifting another portion of the normal polynomial NP according to the second index. The processor 100 may add the first and second shifted normal polynomials NP to each other and add the adding result to the accumulated polynomial AP to update the accumulated polynomial AP. This process may be repeated to perform respective partial product operations between polynomials in a parallel manner.

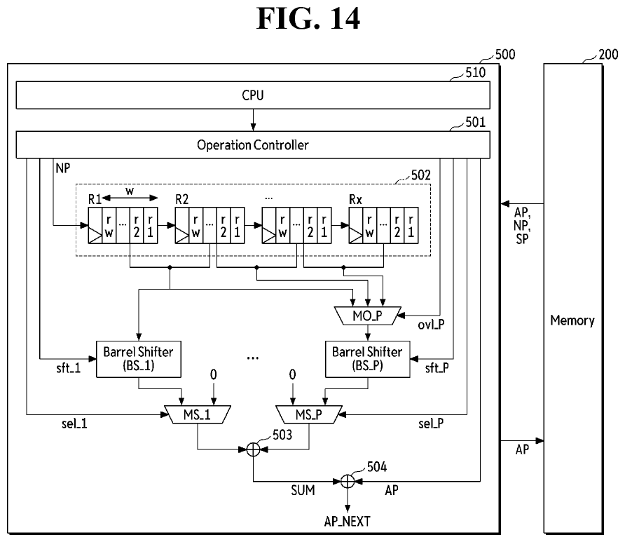

FIG. 14 is a circuit diagram for illustrating an operation device that performs respective partial product operations between polynomials in a parallel manner according to some embodiments.

Referring to FIG. 14, an operation device 500 may be integrated into the processor 100 of FIG. 1 such that the operation device 500 and the processor 100 may be included in the same package. In this case, the operation device 500 may be implemented in the form of hardware in which the multiplier 120 of FIG. 1 includes a logic circuit. However, embodiments are not limited thereto, and the operation device 500 may be disposed outside the processor. The operation device 500 may include an operation controller 501, a central processing unit (CPU) 510, a buffer 502, selectors (e.g., selector circuits) MO_2 to MO_P, first and second adders (e.g., adder circuits) 503 and 504, a barrel shifters (e.g., barrel shifter circuits) BS_1 to BS_P, and a multiplexers MS_1 to MS_P. P is a natural number of 2 or greater, and indicates the number of indexes to be subjected to an operation with the normal polynomial in a parallel manner (e.g., the number of indexes constituting the index set). The operation device 500 may receive the accumulated polynomial AP, the normal polynomial NP, and the sparse polynomial SP from the memory. The received sparse polynomial SP may be in a form of a plurality of indexes constituting the polynomial.

The CPU 510 may control overall operations of the operation device 500. The CPU 510 may be embodied as at least a portion of the processor 100 of FIG. 1 as described above. The CPU 510 may generate a first index set based on the plurality of indexes received from the memory. For example, the CPU 510 may insert the dummy index into the plurality of indexes constituting the first polynomial (e.g., a sparse polynomial in SP) received from a memory (e.g., the memory 200 of FIG. 1), and select two or more adjacent indexes from the plurality of indexes to generate the first index set composed thereof.

More specifically, for example, the CPU 510 may calculate distances between adjacent indexes in a plurality of indexes, and insert a pair of dummy indexes between two adjacent indexes having the maximum distance therebetween. In another example, the CPU 510 may insert a predetermined pair of dummy indexes into the plurality of indexes. In still another example, the CPU 510 may insert a randomly generated pair of dummy indexes into the plurality of indexes.

According to some embodiments, the CPU 510 may shuffle and arrange the plurality of indexes. More specifically, for example, the CPU 510 may randomly select one of a plurality of indexes, arrange the indexes in the ascending or descending order from the selected index, or randomly shuffle and arrange the plurality of indexes.

According to some embodiments, the CPU 510 may select two or more adjacent indexes from the plurality of indexes to generate a plurality of index sets including the first index set, and may shuffle a multiplication operation order with the second polynomial with respect to the plurality of index sets.

The operation controller 501 may control an operation of the operation device 500. The operation controller 501 may provide the normal polynomial NP to the buffer 502. The operation controller 501 may provide the accumulated polynomial AP to the second adder 504. The operation controller 501 may receive the first index set from the CPU 510. The first index set may include a first index to a P-th index. The operation controller 501 may output first to P-th shift signals sft_1 to sft_P based on the first to P-th indexes, respectively. The operation controller 501 may output first to P-th select signals sel_1 to sel_P based on the first to P-th indexes, respectively. The operation controller 501 may output one or more overlap signals ovl_2 to ovl_P based on the first to P-th indexes.

The buffer 502 may receive and store therein the normal polynomial NP from the operation controller 501. For example, the buffer 502 may receive the normal polynomial NP on a word basis every cycle. The buffer 502 may be embodied as a shift register including a plurality of registers R1 to Rx (x is a natural number). Each of the registers R1 to Rx may have a capacity of 1 word (e.g., 32 bits). Accordingly, each of the registers R1 to Rx may store therein the normal polynomial NP in a form divided into words. The buffer 502 may shift the data stored in one register to a next register every predetermined period (e.g., one cycle). For example, the data stored in the first register R1 may be shifted to the second register R2, and the data stored in the second register R2 may be shifted to the third register R3.

The barrel shifters BS_1 to BS_P may be disposed in the operation device 500. The number of barrel shifters BS_1 to BS_P may be equal to the number of indexes to be subjected to an operation with the normal polynomial NP in a parallel manner. For example, the number of barrel shifters BS_1 to BS_P may be P (P is a natural number of 2 or greater). Each of the barrel shifters BS_1 to BS_P may receive corresponding one of the shift signals sft_1 to sft_P. For example, the first barrel shifter BS_1 may receive the first shift signal sft_1, and the P-th barrel shifter BS_P may receive the P-th shift signal sft_P. Each of the shift signals sft_1 to sft_P may indicate the number of times an input value is to be shifted based on a corresponding index. Each of the barrel shifters BS_1 to BS_P may determine a number of times to shift an input value based on a corresponding index and a corresponding shift signal. For example, the shift signal corresponding to an index of 1 may shift a value input to the barrel shifter by 1 bit. The first barrel shifter BS_1 may be connected to the first and second registers R1 and R2. The first barrel shifter BS_1 may receive portions of the normal polynomials NP respectively stored in the first and second registers R1 and R2 from the first and second registers R1 and R2. Each of the other barrel shifters BS_2 to BS_P except for the first barrel shifter BS_1 may receive another portion of the normal polynomial NP from corresponding one of the selectors MO_2 to MO_P.

The selectors MO_2 to MO_P may be disposed in the operation device 500. The number of selectors MO_2 to MO_P may be (P-1). Each of the selectors MO_2 to MO_P may be connected to corresponding one of the barrel shifters BS_2 to BS_P. Each of the selectors MO_2 to MO_P may receive data respectively stored in two adjacent registers from the two adjacent registers, select one of the received data therefrom based on each of the received overlap signals ovl_2 to ovl_P, and provide the selected data to corresponding one of the barrel shifters BS_2 to BS_P.

The multiplexers MS_1 to MS_P may be disposed in the operation device 500 and the number thereof may be equal to the number of indexes to be subjected to an operation with the normal polynomial NP in a parallel manner. Each of the multiplexers MS_1 to MS_P may be connected to corresponding one of the barrel shifter BS_1 to BS_P. Each of the multiplexers MS_1 to MS_P may output one of the output of corresponding one of the barrel shifters BS_1 to BS_P and ‘0’ based on corresponding one of the select signals sel_1 to sel_P. The select signal will be described in more detail below.

The first adder 503 may add all the outputs of the plurality of multiplexers MS_1 to MS_P to each other and output the adding result as a sum signal SUM. Because the polynomials to be subjected to the multiplication operation are elements on the binary extension finite field GF(2ⁿ), the first adder 503 may be embodied as an XOR operator that performs the modulo-2 addition.

The second adder 504 may add the sum signal SUM as the output of the first adder 503 to the accumulated polynomial AP to output an updated accumulated polynomial AP_NEXT. Like the first adder 503, the second adder 504 may be embodied as an XOR operator that performs the modulo-2 addition. The operation controller 501 may update the accumulated polynomial AP and provide the updated the accumulated polynomial AP to the CPU 510 and/or the memory 200.

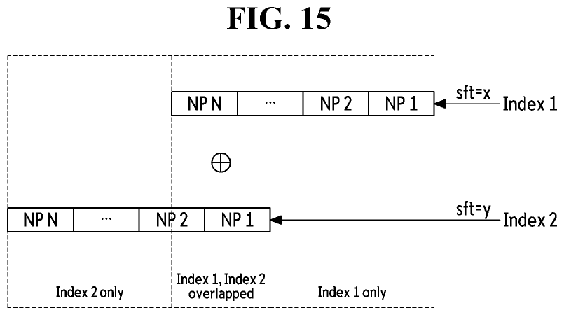

FIG. 15 is a diagram for illustrating an operation of an operation device that performs respective partial product operations between polynomials in a parallel manner according to some embodiments.

Referring to FIGS. 14 and 15, the operation of the operation device 500 that performs the respective partial product operations between the polynomials in a parallel manner may vary largely according to three cases. For convenience of description, it is assumed that the first index set includes a first index Index_1 and a second index Index_2. In a first case, the first index Index_1 and the second index Index_2 do not overlap each other, and thus, only the first index Index_1 is subjected to the operation (Index 1 only). In this case, the operation device 500 may shift a portion of the normal polynomial NP by the first index Index_1. The operation may be performed on a word basis.

In a second case, the first index Index_1 and the second index Index_2 partially overlap each other and thus the respective overlapping portions of the first index Index_1 and the second index Index_2 are simultaneously subjected to the operation (Index1, Index2 overlapped). In this case, the operation device 500 may shift a portion of the normal polynomial NP on a word basis by the first index Index_1, shift another portion of the normal polynomial NP on a word basis by the second index Index_2, and then add the shifted outputs to each other. The operation may be performed on a word basis.

In a third case, the first index Index_1 and the second index Index_2 do not overlap each other, and thus, only the second index Index_2 is subjected to the operation (Index 2 only). In this case, the operation device 500 may shift a portion of the normal polynomial NP by the second index Index_2. The operation may be performed on a word basis.

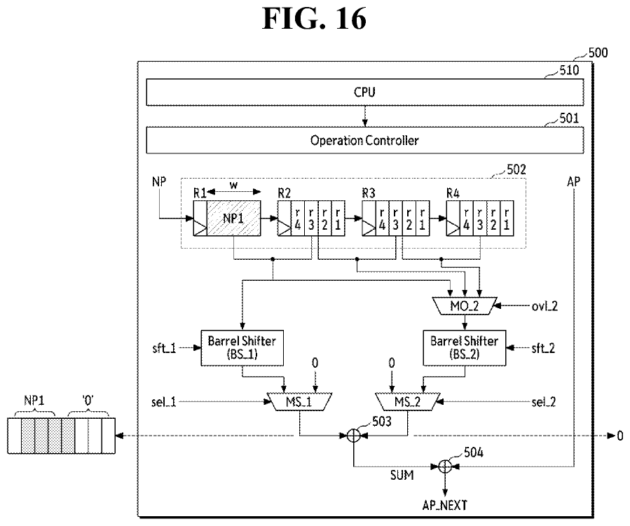

FIG. 16 is a diagram for illustrating an operation of an operation device that performs respective partial product operations between polynomials in a parallel manner according to some embodiments.

The first case (Index 1 only) in which the first index Index_1 and the second index Index_2 do not overlap each other and thus only the first index Index_1 is subjected to the operation will be described by way of example with reference to FIG. 16. For convenience of description, it is assumed that the first index set includes two indexes Index_1=1 and Index_2=11. That is, the number of indexes to be subjected to an operation with the normal polynomial NP in a parallel manner is two. In addition, it is assumed that the size of the word is 4 bits, the size of the normal polynomial is 32 bits, and the size of the buffer 502 is 16 bits. Initially, it is assumed that each of the registers R1 to R4 of the buffer 502 is initialized to ‘0’.

The operation may be performed on a word basis. The first register R1 of the buffer 502 may receive and store therein a first portion NP1 of the normal polynomial NP from the operation controller 501. The first barrel shifter BS_1 may receive a total of 8-bit data signals stored in the first and second registers R1 and R2 from the buffer 502, and may select a portion corresponding to a word currently subjected to the operation when the received data signal has been shifted based on the first shift signal sft_1.

For example, the first barrel shifter BS_1 receives the values stored in the first and second registers R1 and R2. Thus, the values received by the first barrel shifter BS_1 are 4 bits corresponding to the first portion NP1 and 4 bits initialized to ‘0’, and thus are data of 8 bits in total. The first index is 1. Thus, upon the shift by the first index, the portion corresponding to the word currently subjected to the operation is the lower 3 bits of the first portion NP1 and the most significant bit among the 4 bits initialized to 0. That is, the first barrel shifter BS_1 may select the lower 3 bits of the first portion NP1 and the most significant bit among the 4 bits initialized to 0 as the portion corresponding to the word currently subjected to the operation, upon the shift based on the first shift signal sft_1.

The first barrel shifter BS_1 may shift the selected portion based on the first shift signal sft_1. The first barrel shifter BS_1 may shift the selected portion based on the first shift signal sft_1 by the first index Index_1 and output the shifted portion.

The first multiplexer MS_1 may receive the first select signal sel_1, and may select one of the output of the first barrel shifter BS_1 or ‘0’ based on the first select signal sel_1 and may output the selected one. In the first case (Index 1 only) in which only the first index is subjected to the operation, the first multiplexer MS_1 may select and output the output of the first barrel shifter BS_1 based on the first select signal sel_1. In the first case (Index 1 only) in which only the first index is subjected to the operation, the second multiplexer MS_2 may output ‘0’ based on the second select signal sel_2. The first adder 503 may add all the outputs of the multiplexers to each other and output the adding result as a sum signal SUM. The second adder 504 may add the sum signal SUM and the accumulated polynomial AP to each other to output an updated accumulated polynomial AP_NEXT. Thereafter, the first register R1 of the buffer 502 may receive and store therein a second portion NP2 of the normal polynomial NP from the operation controller 501, and may shift the first portion NP1 stored in the first register R1 to the second register R2. Thereafter, the operation on the word currently subjected to the operation may be terminated, and an operation on a next word may be started.

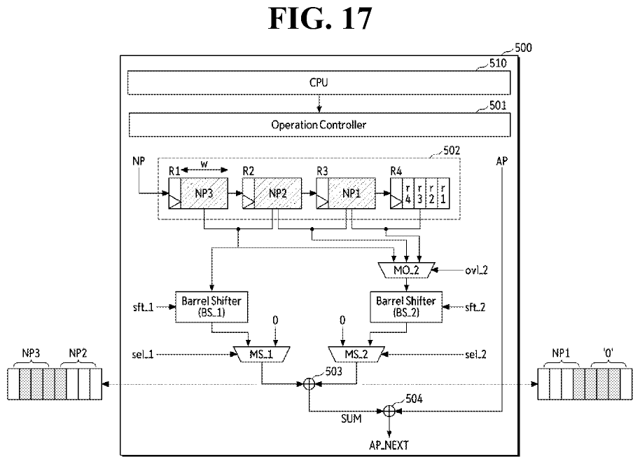

FIG. 17 is a diagram for illustrating an operation of an operation device that performs respective partial product operations between polynomials in a parallel manner according to some embodiments.

Referring to FIG. 17, the second case (Index 1, Index 2 overlapped) in which respective overlapping portions of the first index Index_1 and the second index Index_2 are simultaneously subjected to the operation will be described by way of example. For convenience of description, it is assumed that the first index set includes two indexes Index_1=1 and Index_2=11. That is, the number of indexes to be subjected to an operation with the normal polynomial NP in a parallel manner is two. In addition, it is assumed that the size of the word is 4 bits, the size of the normal polynomial is 32 bits, and the size of the buffer 502 is 16 bits. Initially, it is assumed that the registers R1 to R4 of the buffer 502 are initialized to ‘0’.

The operation may be performed on a word basis. Because the size of the word is 4 bits and the distance between the two indexes is 10, the operation on the overlapping portion between the first index Index_1 and the second index Index_2 may be started from a time when the buffer 502 receives a third portion NP3 of the normal polynomial NP. The first register R1 of the buffer 502 may receive and store therein the third portion NP3 of the normal polynomial NP from the operation controller 501. In addition, the second portion NP2 of the normal polynomial NP may be stored in the second register R2 of the buffer 502, and the third portion NP3 of the normal polynomial NP may be stored in the third register R3.

The first barrel shifter BS_1 may receive a total of 8 bits of data stored in the first and second registers R1 and R2 from the buffer 502. Upon the shift from the received data signal based on the first shift signal sft_1, the first barrel shifter BS_1 may select a portion corresponding to a word currently subjected to the operation. For example, the first index Index_1 is 1. Thus, upon the shift based on the first shift signal sft_1, the first barrel shifter BS_1 may select the lower 3 bits of the third portion NP3 and the most significant bit among the 4 bits of the second portion NP2 as the portion corresponding to the word currently subjected to the operation. The first barrel shifter BS_1 may shift the selected portion based on the first shift signal sft_1 and output the shifted portion. The first barrel shifter BS_1 may shift the selected portion based on the first shift signal sft_1 by the first index Index_1. The first multiplexer MS_1 may receive the first select signal sel_1, and may select and output one of the output of the first barrel shifter BS_1 or ‘0’ based on the first select signal sel_1. In the second case (Index 1, Index 2 overlapped) in which the respective overlapping portions of the first index Index_1 and the second index Index_2 are simultaneously subjected to the operation, the first multiplexer MS_1 may select and output the output of the first barrel shifter BS_1 based on the first select signal sel_1.

The selector MO_2 may receive values stored in two adjacent registers from the buffer 502. For example, the selector MO_2 may receive the 8-bit data signal stored in the first and second registers R1 and R2, the 8-bit data signal stored in the second and third registers R2 and R3, and the 8-bit data signal stored in the third and fourth registers R3 and R4. The selector MO_2 may select a signal including a portion corresponding to a word currently subjected to the operation of the shift among the received data signals based on the overlap signal ovl_2. The overlap signal ovl_2 may be generated based on the second index Index_2. For example, The second index Index_2 is 11. Thus, upon the shift by the second index Index_2, a portion corresponding to a word currently subjected to the operation is the least significant bit of the first portion NP1 and the upper 3 bits of the 4 bits initialized to 0. That is, the selector MO_2 may select the data signal received from the third and fourth registers R3 and R4 which is the 8-bit data signal including the least significant bit of the first portion NP1 and the 4 bits initialized to 0, based on the overlap signal ovl_2, and provide the selected data signal to the second barrel shifter BS_2.

The second barrel shifter BS_2 may receive the data signal including the portion corresponding to the word currently subjected to the operation from the selector MO_2, and may select the portion corresponding to the word currently subjected to the operation of the shift based on the second shift signal sft_2. For example, the second index Index_2 is 11. Thus, the second barrel shifter BS_2 may select the least significant bit LSB of the first portion NP1 and the upper 3 bits among the 4 bits initialized to 0. The second barrel shifter BS_2 may shift the selected portion based on the second shift signal sft_2. The second barrel shifter BS_2 may shift the selected portion by the second index Index_2 based on the second shift signal sft_2.

The second multiplexer MS_2 may receive the second select signal sel_2, and may select and output one of the output of the second barrel shifter BS_2 or ‘0’ based on the second select signal sel_2. In the second case (Index 1, Index 2 overlapped) in which the respective overlapping portions of the first index Index_1 and the second index Index_2 are simultaneously subjected to the operation, the second multiplexer MS_2 may select and output the output of the second barrel shifter BS_2 based on the second select signal sel_2.

The first adder 503 may add all the outputs of the multiplexers to each other and output the adding result as a sum signal SUM. The second adder 504 may add the sum signal SUM and the accumulated polynomial AP to each other to output an updated accumulated polynomial AP_NEXT. Thereafter, the first register R1 of the buffer 502 may receive and store therein a fourth portion NP4 of the normal polynomial NP from the operation controller 501, and may shift the third portion NP3 stored in the first register R1 to the second register R2. Thereafter, the operation on the word currently subjected to the operation may be terminated, and an operation on a next word may be started.

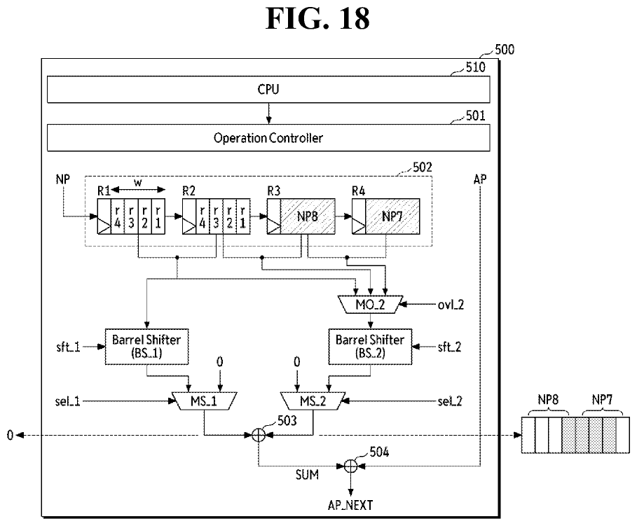

FIG. 18 is a diagram for illustrating an operation of an operation device that performs respective partial product operations between polynomials in a parallel manner according to some embodiments.

The case Index 2 only in which the first index Index_1 and the second index Index_2 do not overlap each other and thus only the second index Index_2 is subjected to the operation (Index_2) will be described by way of example with reference to FIG. 18. For convenience of description, it is assumed that the first index set includes two indexes Index_1=1 and Index_2=11. That is, the number of indexes to be subjected to an operation with the normal polynomial NP in a parallel manner is two. In addition, it is assumed that the size of the word is 4 bits, the size of the normal polynomial is 32 bits, and the size of the buffer 502 is 16 bits. Initially, it is assumed that each of the registers R1 to R4 of the buffer 502 is initialized to ‘0’.

The operation may be performed on a word basis. Because the size of the normal polynomial is 32 bits, the size of the word is 4 bits, and the distance between the two indexes is 10, the operation on only the second index Index_2 may be started from a time when the third register R3 receives an eighth portion NP8 of the normal polynomial NP. The eighth portion NP8 of the normal polynomial NP may be stored in the third register R3 of the buffer 502, and the seventh portion NP7 of the normal polynomial NP may be stored in the fourth register R4.

The first multiplexer MS_1 may receive the first select signal sel_1, and may select and output one of the output of the first barrel shifter BS_1 or ‘0’ based on the first select signal sel_1. In the first case (Index 1 only) in which only the first index Index_1 is subjected to the operation, the first multiplexer MS_1 may select and output ‘0’ based on the first select signal sel_1.

The selector MO_2 may receive values stored in two adjacent registers from the buffer 502. For example, the selector MO_2 may receive the 8-bit data signal stored in the first and second registers R1 and R2, the 8-bit data signal stored in the second and third registers R2 and R3, and the 8-bit data signal stored in the third and fourth registers R3 and R4. The selector MO_2 may select a signal including a portion corresponding to a word currently subjected to the operation of the shift among the received data signals based on the overlap signal ovl_2. For example, the second index Index_2 is 11. Thus, upon the shift by the second index, the portion corresponding to the word currently subjected to the operation is the least significant bit of the eighth portion NP8 and the upper 3 bits among the 4 bits of the seventh portion NP7. That is, the selector MO_2 may select the data signal received from the third and fourth registers R3 and R4 which is the data signal of 8 bits including the least significant bit of the eighth portion NP8 and the upper 3 bits among the 4 bits of the seventh portion NP7, based on the overlap signal ovl_2, and provide the selected data signal to the second barrel shifter BS_2.

The second barrel shifter BS_2 may receive a data signal including a portion corresponding to a word currently subjected to the operation from the selector MO_2, and may select a portion corresponding to a word currently subjected to the operation of the shift based on the second shift signal sft_2. For example, because the second index Index_2 is 11, the second barrel shifter BS_2 may select the upper 3 bits from among the least significant bits of the 8 portion NP8 and the 4 bits of the seventh portion NP7. The second barrel shifter BS_2 may shift the selected portion based on the second shift signal sft_2. The second barrel shifter BS_2 may shift a value selected based on the second shift signal sft_2 by the second index Index_2.

The second multiplexer MS_2 may receive the second select signal sel_2, and may select and output one of the output of the second barrel shifter BS_2 or ‘0’ based on the second select signal sel_2. When only the second index is subjected to the operation (Index 2 only), the second multiplexer MS_2 may select and output the output of the second barrel shifter BS_2 based on the second select signal sel_2.

The first adder 503 may add all the outputs of the multiplexers to each other and output the adding result as a sum signal SUM. The second adder 504 may add the sum signal SUM and the accumulated polynomial AP to each other to output an updated accumulated polynomial AP_NEXT. Thereafter, the buffer 502 may shift the eighth portion NP8 stored in the third register R3 to the fourth register R4. Thereafter, the operation on the word currently subjected to the operation may be terminated, and an operation on a next word may be started.

According to some embodiments, the method for performing an operation which is safe against the side channel attack may insert the dummy index to hide the distance information between the indexes as the secret information from the attacker. Furthermore, the method may equalize the distances between the indexes with each other and allow the shift operation to be performed at an uniform time interval, thereby making it difficult for the attacker to analyze an operation timing.

According to some embodiments, the method for performing an operation which is safe against the side channel attack shuffles the operation orders of the indexes with the normal polynomial, thereby making it difficult for the attacker to identify the index subjected to the operation at a specific time.

According to some embodiments, the operation device may simultaneously operate the P indexes (P is a natural number greater than or equal to 2) with the normal polynomial via one-time normal polynomial loading. That is, the operation device may reduce the number of times of the normal polynomial loading to accelerate the operation and to prevent performance degradation due to an increase in an amount of operation due to the application of the side channel attack defense technique such as the dummy index insertion.

When the respective operations between the indexes and the normal polynomial are performed in the parallel manner, an additional internal buffer space may be used due to the distances between the indexes subjected to the operation with the normal polynomial in the parallel manner. That is, the introduction of the parallel operation structure may accelerate the operation, but causes an increase in the internal buffer size of the operation device. According to some embodiments, in the method for performing an operation that is safe against a side channel attack, the dummy index may be inserted between the indexes to reduce the distance between the indexes, and thus an increase in an internal buffer size of the operation device may be minimized while accelerating the operation.

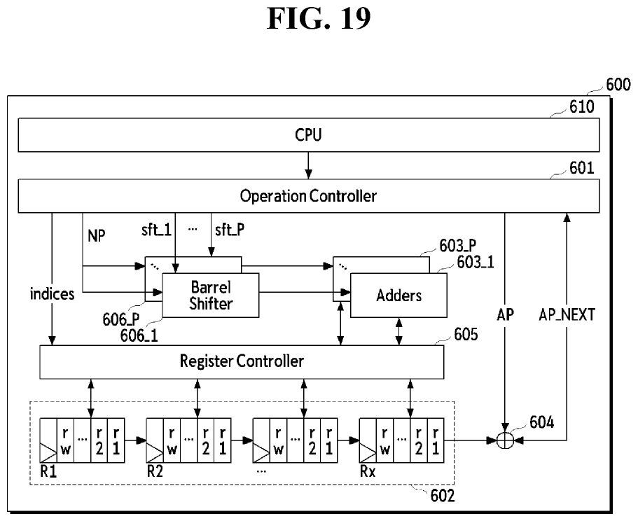

FIG. 19 is a circuit diagram for illustrating an operation device that performs respective partial product operations between polynomials in a parallel manner according to some embodiments.

The operation device 500 of FIG. 14 may have a circuit structure varying according to an embodiment. Referring to FIG. 19, an operation device 600 may have a different circuit structure from that of the operation device 500 of FIG. 14. The operation device 600 has the different circuit structure from that of the operation device 500 of FIG. 14, while the method for performing an operation in the device in FIG. 19 is similar to that in the device in FIG. 14. The operation device 600 may be integrated in the processor 100 of FIG. 1 such that the operation device 600 and the processor 100 are included in the same package. In this case, the operation device 600 may be implemented in the form of hardware in which the multiplier 120 of FIG. 1 includes a logic circuit. However, embodiments are not limited thereto, and the operation device 600 may be disposed outside the processor. The operation device 600 may include an operation controller 601, a central processing unit (CPU) 610, a buffer 602, a first adder 603, a second adder 604, a register controller 605, and a barrel shifter 606. The operation device 600 may receive the accumulated polynomial AP, the normal polynomial NP, and the sparse polynomial SP from the memory. The received sparse polynomial SP may be in the form of a plurality of indexes constituting the polynomial.

The CPU 610 may control overall operations of the operation device 600. The CPU 610 may be embodied as at least a portion of the processor 100 of FIG. 1 described above. For example, the CPU 610 may generate a first index set based on a plurality of indexes received from the memory and provide the first index set to the operation controller 601. For example, the CPU 610 may insert a dummy index into a plurality of indexes constituting a first polynomial (e.g., a sparse polynomial in SP) received from a memory (e.g., the memory 200 of FIG. 1), and select two or more adjacent indexes from the plurality of indexes to generate the first index set composed of the selected two or more adjacent indexes.

More specifically, for example, the CPU 610 may calculate distances between adjacent indexes in the plurality of indexes, and insert a pair of dummy indexes between two adjacent indexes having the maximum distance therebetween. In another example, the CPU 610 may insert a predetermined pair of dummy indexes into the plurality of indexes. In another example, the CPU 610 may insert a randomly generated pair of dummy indexes into the plurality of indexes.

According to some embodiments, the CPU 610 may shuffle and arrange the plurality of indexes. More specifically, for example, the CPU 610 may randomly select one of the plurality of indexes, arrange the indexes in the ascending or descending order from the selected index, or may randomly shuffle and arrange the plurality of indexes.

According to some embodiments, the CPU 610 may select two or more adjacent indexes from the plurality of indexes to generate a plurality of index sets including the first index set, and may shuffle an order of respective multiplication operations between the second polynomial and the plurality of index sets.

The operation controller 601 may control an operation of the operation device 600. The operation controller 601 may provide the normal polynomial NP to the barrel shifters 606_1 to 606_P. The operation controller 601 may provide the accumulation polynomial AP to the second adder 604. The operation controller 601 may receive the first index set from the CPU 610.

The first index set may include a first index to a P-th index. For convenience of description, it is assumed that P is 2. The operation controller 601 may output the first and second shift signals sft_1 and sft_2 based on the first and second indexes, respectively, and provide the first and second shift signals sft_1 and sft_2 to the barrel shifters 606_1 to 606_P.

The barrel shifters 606_1 to 606_P may receive the normal polynomial NP and one or more shift signals sft_1 to sft_P. The barrel shifters 606_1 to 606_P may shift the normal polynomial NP respectively based on one or more shift signals sft_1 to sft_P and output one or more shifted normal polynomials NP.

The operation controller 601 may load data stored in the shift register using the register controller 605, and perform an addition operation between the loaded data and the received shifted normal polynomial using the first adder 603 to obtain a sum signal. The register controller 605 may receive the sum signal SUM and store the sum signal in the buffer 602 based on the first and second indexes. The buffer 602 may be embodied as a shift register composed of a plurality of registers. The second adder 604 may add the output of the buffer 602 and the accumulated polynomial AP to obtain an updated accumulated polynomial AP_NEXT and may output the obtained updated accumulated polynomial AP_NEXT. The updated accumulated polynomial AP_NEXT may be provided to the operation controller 601. The operation controller 601 may further perform an operation based on the updated accumulated polynomial AP_NEXT, or may provide the updated accumulated polynomial AP_NEXT to the CPU 610 and/or the memory.

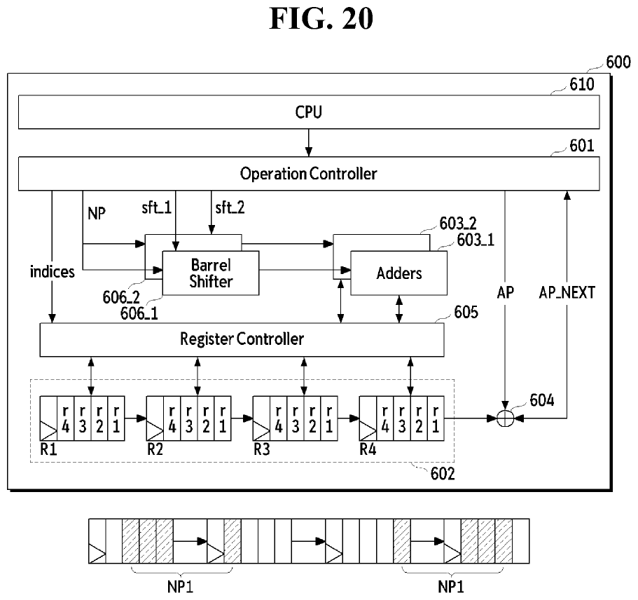

FIGS. 20 to 22 are diagrams for illustrating an operation of an operation device that performs respective partial product operations between polynomials in a parallel manner according to some embodiments.

In FIGS. 20 to 22, a second case (Index 1, Index 2 overlapped) in which the respective overlapping portions of the first index Index_1 and the second index Index_2 are simultaneously subjected to the operation will be described by way of example. For convenience of description, it is assumed that the first index set includes two indexes Index_1=1 and Index_2=11. That is, the number of indexes to be subjected to an operation with the normal polynomial NP in a parallel manner is two. In addition, it is assumed that the size of the word is 4 bits, the size of the normal polynomial is 32 bits, and the size of the buffer 602 is 16 bits. Initially, it is assumed that each of the registers R1 to R4 of the buffer 602 is initialized to ‘0’.

Referring to FIGS. 20 to 22, the operation controller 601 may provide the normal polynomial to the barrel shifters 606_1 and 601_2 on a word basis, and may provide the shift signals sft_1 and sft_2 based on the index values to the barrel shifters 606_1 and 601_2. Each of the barrel shifters 606_1 and 601_2 may shift the received normal polynomial by the index and provide the shifted normal polynomial to the first adders 603_1 and 603_2. The operation controller 601 may load the data stored in the buffer 602 to the first adders 603_1 and 603_2 via the register controller 605. Each of the first adders 603_1 and 603_2 may add the loaded data and the shifted normal polynomial to each other and provide the adding result to the register controller 605. The register controller 605 may receive the indexes and store the received addition result at an appropriate location in the buffer 602 based on the indexes.

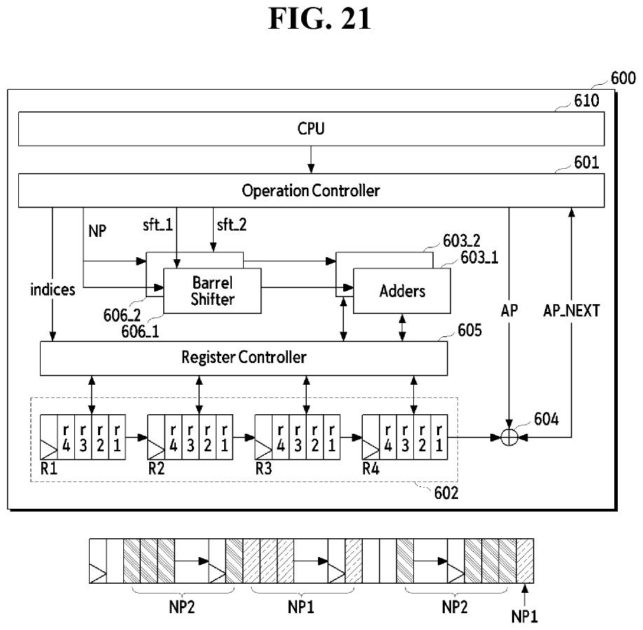

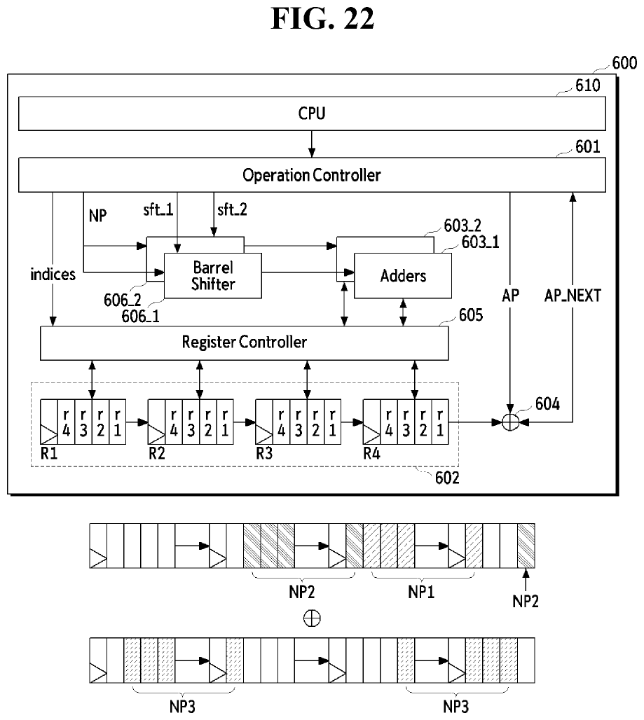

The lower portion of FIG. 20 indicates a value stored in the buffer 602 in the middle of the operation. In the present example, the two index values are 1 and 11. Thus, the first portion NP1 of the normal polynomial may be stored as shown in FIG. 20. The lower portion of FIG. 21 indicates a value stored in the buffer 602 in the middle of the operation. The buffer 602 may be a shift register, and data stored every cycle may be shifted on a word basis. Accordingly, the first and second portions NP1 and NP2 of the normal polynomial may be stored as shown in FIG. 21. The lower portion of FIG. 22 indicates a value stored in buffer 602. Each of the first adders 603_1 and 603_2 may add the data loaded from the buffer 602 and the shifted normal polynomial to each other. In the present example, the two index values are 1 and 11 such that the first portion NP1 and the third portion NP3 may overlap each other.

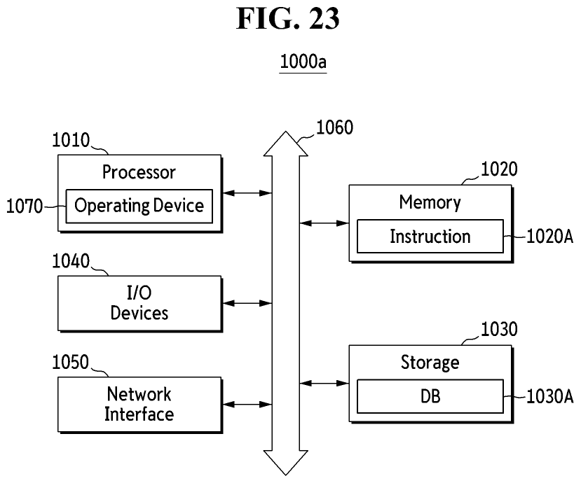

FIG. 23 is a diagram for illustrating a computing system according to some embodiments.

Referring to FIG. 23, a computing system 1000a may correspond to the system 1 of FIG. 1. The computing system 1000a may be a stationary computing system, such as a desktop computer, workstation, server, or the like, or may be a portable computing system, such as a laptop computer, or the like.

The computing system 1000a may include a processor 1010, a memory 1020, a storage device 1030, input/output devices 104, and a network interface 1050. The processor 1010, the memory 1020, the storage device 1030, the input/output devices 1040, and the network interface 1050 may be connected to a bus 1060 and communicate with each other via the bus 1060.

The processor 1010 may be referred to as a processing unit, and may include at least one core capable of executing any instruction set (e.g., Intel Architecture-32(IA-32 ), 64-bit extended IA-32, x86-64, PowerPC, Sparc, MIPS, ARM, IA-64, etc.) such as a microprocessor, an application processor (AP), a digital signal processor (DSP), a graphic processing unit (GPU), etc. The processor 1010 may access the memory 1020 via the bus 1060 and may execute the instructions 1020A stored in the memory 1020. When the instructions 1020A are executed by the processor 1010, the instructions 1020A may cause the processor 1010 to perform the method for performing an operation which is safe against the side channel attack described above.

The memory 1020 may store therein the instructions 1020A or at least some thereof for performing a method for performing an operation being safe against a side channel attack according to some embodiments. The instructions 1020A may cause the processor 1010 to perform at least some of the operations included in the method for performing an operation which is safe against the side channel attack.

The storage device 1030 may not lose data stored therein even when power supplied to the computing system 1000a is cut off. For example, the storage device 1030 may include a non-volatile integrated circuit or may include a storage medium such as a magnetic tape, an optical disk, or a magnetic disk. In addition, the storage device 1030 may be detachable from the computing system 1000a.

The storage device 1030 may store therein the instructions 1020A. The instructions 1020A or at least some thereof may be loaded from the storage device 1030 to the memory 1020 before the instructions 1020A are executed by the processor 1010. In another embodiment, the storage device 1030 may store therein a file written in a program language, and the instructions 1020A generated by a compiler or the like from the file or at least some thereof may be loaded into the memory 1020. In addition, the storage device 1030 may store therein database 1030A, and the database 103A may include information necessary to perform the method for performing an operation being safe against a side channel attack, for example, the normal polynomial, the accumulated polynomial, and the plurality of indexes constituting the sparse polynomial.

The storage device 1030 may store therein data to be processed by the processor 1010 or data processed by the processor 1010. That is, the processor 1010 may generate new data by processing data stored in the storage device 1030 according to the instructions 1020A, and may store the newly generated data in the storage device 1030.

The input/output devices 1040 may include an input device such as a keyboard, a pointing device, or the like, and may include an output device such as a display device, a printer, or the like. For example, the user may trigger execution of the instructions 1020A by the processor 1010 via the input/output devices 1040.

The network interface 1050 may provide access to a network external to the computing system 1000a. For example, the network may include multiple computing systems and communication links, and the communication links may include wired links, optical links, wireless links, or any other form of links.

According to some embodiments, the processor 1010 may include an operation device 1070 for performing an operation. The operation device 1070 may correspond to the operation device 500 of FIG. 14 or the operation device 600 of FIG. 19. The processor 1010 may receive the normal polynomial, the accumulated polynomial, and the plurality of indexes constituting the sparse polynomial from the memory 1020. For example, the processor 1010 may perform at least some of the operations of the method for performing an operation that is safe against a side channel attack to generate the accumulated polynomial, the normal polynomial, and the first index set and provide the accumulated polynomial, the normal polynomial, and the first index set to the operation device 1070. The operation device 1070 may be embodied as a hardware circuit including logic circuits. The operation device 1070 may perform at least some of the operations of the method for performing an operation that is safe against the side channel attack to obtain the updated accumulated polynomial and provide the updated accumulated polynomial to the processor 1010. The processor 1010 may store the updated accumulated polynomial in the memory 1020.

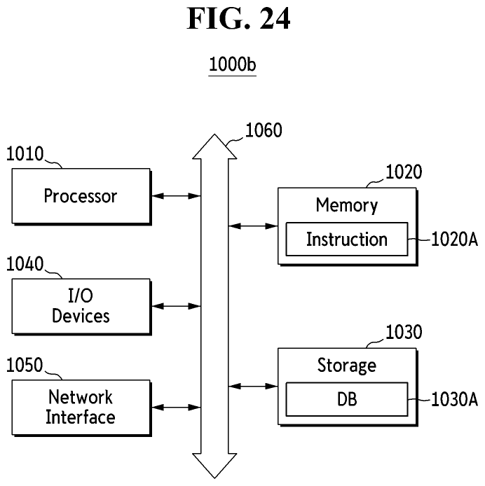

FIG. 24 is a diagram for illustrating a computing system according to some embodiments.

In FIG. 24, a description of contents duplicate with those of FIG. 23 will be omitted. Referring to FIG. 24, the processor 1010 may receive the normal polynomial, the accumulated polynomial, and the plurality of indexes constituting the sparse polynomial from the memory 1020. Unlike FIG. 23, the processor 1010 may obtain the updated accumulated polynomial by performing at least some of the operations of the method for performing an operation being safe against the side channel attack, based on the normal polynomial, the accumulated polynomial, and the plurality of indexes constituting the sparse polynomial. The processor 1010 may store the updated accumulated polynomial in the memory 1020.

According to some embodiments of present disclosure, the central processing unit is further configured to randomly shuffle and arrange the plurality of indexes including the dummy index.

According to some embodiments of present disclosure, the central processing unit is further configured to select two or more adjacent indexes from the plurality of indexes including the dummy index to generate a plurality of index sets, the plurality of index sets including the first index set, and shuffle an order of respective multiplication operations between a second polynomial and the plurality of index sets.

While aspects of embodiments have been particularly shown and described, it will be understood that various changes in form and details may be made therein without departing from the spirit and scope of the following claims.

What is claimed is:

1. A method for performing an operation, the method comprising:
inserting, by a processor, a dummy index into a plurality of indexes constituting a first polynomial;
selecting, by the processor, two or more adjacent indexes from among the plurality of indexes including the dummy index;
generating, by the processor, a first index set comprising the selected two or more adjacent indexes; and
performing, by the processor, partial product operations between indexes belonging to the first index set and a second polynomial in a parallel manner.

2. The method of claim 1, wherein the inserting of the dummy index into the plurality of indexes comprises:
identifying distances between adjacent indexes in the plurality of indexes; and
inserting a pair of dummy indexes between two adjacent indexes having a maximum distance therebetween.

3. The method of claim 1, wherein the inserting of the dummy index into the plurality of indexes comprises inserting a predetermined pair of dummy indexes into the plurality of indexes.

4. The method of claim 1, wherein the inserting of the dummy index into the plurality of indexes comprises inserting a randomly generated pair of dummy indexes into the plurality of indexes.

5. The method of claim 1, further comprising shuffling and arranging, by the processor, the plurality of indexes including the dummy index.

6. The method of claim 5, wherein the shuffling and arranging of the plurality of indexes including the dummy index comprises:
randomly selecting one of the plurality of indexes; and
arranging the plurality of indexes including the dummy index in an ascending or descending order from the selected index as an initial index.

7. The method of claim 5, wherein the shuffling and arranging of the plurality of indexes comprises randomly shuffling and arranging the plurality of indexes including the dummy index.

8. The method of claim 1, wherein the selecting of the two or more adjacent indexes from among the plurality of indexes to generate the first index set comprises:
selecting the two or more adjacent indexes from the plurality of indexes including the dummy index to generate a plurality of index sets, the plurality of index sets including the first index set; and
shuffling an order of respective multiplication operations between the plurality of index sets and the second polynomial.

9. The method of claim 1, wherein the performing of the respective partial product operations between the second polynomial and the indexes belonging to the first index set in a parallel manner comprises:
shifting a portion of the second polynomial respectively based on p indexes to respectively obtain p shifted second polynomials, wherein p is a natural number of 2 or greater;
adding all of the p shifted second polynomials to each other to obtain a sum value; and
adding the sum value to an accumulated polynomial to obtain an updated accumulated polynomial.

10. A device for performing an operation, the device comprising:
an operation controller configured to output a first index set including a first index and a second index, a first polynomial, and an accumulated polynomial;
a buffer configured to receive and store the first polynomial;
a first barrel shifter circuit configured to receive a first portion of the first polynomial from the buffer and shift the first portion according to the first index;
a second barrel shifter circuit configured to receive a second portion of the first polynomial from the buffer and shift the second portion according to the second index;
a first adder circuit configured to sum respective outputs of the first barrel shifter circuit and the second barrel shifter circuit; and
a second adder circuit configured to add an output of the first adder circuit to the accumulated polynomial to obtain an updated accumulated polynomial and output the obtained updated accumulated polynomial.

11. The device of claim 10, wherein the buffer comprises a shift register composed of a plurality of registers.

12. The device of claim 11, wherein the plurality of registers comprises a first register configured to receive a portion of a second polynomial from the operation controller, and a second register adjacent to the first register, and
wherein the first barrel shifter circuit is connected to the first register and the second register.

13. The device of claim 11, further comprising a selector circuit configured to:
respectively receive data signals from two adjacent registers among the plurality of registers;
select one of the received data signals based on an overlap signal received from the operation controller; and
provide the selected data signal to the second barrel shifter circuit.

14. The device of claim 10, further comprising a central processing unit, wherein the central processing unit is configured to:
insert a dummy index into a plurality of indexes constituting the first polynomial received from a memory;
select two or more adjacent indexes from the plurality of indexes including the dummy index;
generate the first index set comprising the selected two or more adjacent indexes; and
provide the generated first index set to the operation controller.

15. The device of claim 14, wherein the central processing unit is further configure to:
identify distances between adjacent indexes in the plurality of indexes; and
insert a pair of dummy indexes between two adjacent indexes having a maximum distance therebetween.

16. The device of claim 14, wherein the central processing unit is further configured to insert a predetermined pair of dummy indexes into the plurality of indexes.

17. The device of claim 14, wherein the central processing unit is further configured to insert a randomly generated pair of dummy indexes into the plurality of indexes.

18. The device of claim 14, wherein the central processing unit is further configured to shuffle and arrange the plurality of indexes including the dummy index.

19. The device of claim 18, wherein the central processing unit is further configured to randomly select one of the plurality of indexes including the dummy index and to arrange the plurality of indexes including the dummy index in an ascending or descending order from the selected index.

20. A computing system comprising:
a processor; and
a memory storing instructions therein,
wherein when the instructions are executed by the processor, the instructions cause the processor to:
insert a dummy index into a plurality of indexes constituting a first polynomial;
select two or more adjacent indexes from among the plurality of indexes including the dummy index;
generate a first index set composed of the selected two or more adjacent indexes; and
perform respective partial product operations between indexes belonging to the first index set and a second polynomial in a parallel manner.
